(19) United States
(12) Patent Application Publication
(10) Pub. No.: US 2009/0140905 A1
(43) Pub. Date: Jun. 4, 2009

(54) SYSTEM AND METHOD FOR CONTROLLING SERVICES IN A HOME ENVIRONMENT

(75) Inventor: Johannes H.M. Lemmers, Reek (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/909,803

(22) PCT Filed: Mar. 29, 2006
(86) PCT No.: PCT/IB2006/050955

§ 371 Date: Sep. 27, 2007

Related U.S. Application Data
(60) Provisional application No. 60/666,493, filed on Mar. 30, 2005.

(51) Int. Cl. G08C 19/12

(52) U.S. Cl. 341/176

(57) ABSTRACT

A system and method is provided for assigning services to users of a home entertainment system environment, wherein the home entertainment system environment includes a computing system (102) comprised of a centralized computing device (100) configured to coordinate the lifecycle of a plurality of services (12-24). Access to said computing system (102) is achieved via user controlled remote access devices (40). Once access is established, the users are shown a listing of a plurality of services (12-24) and their corresponding service label identifiers. Selection of one or more preferred services (12-24) by a user is facilitated through use of the preferred service label identifiers. Once a selection is made by a user, assignment of the preferred service is made to the user's remote access device. Advantageously, only the assigned service is controlled by the user's remote control device without causing unintended control of the non-selected services. According to another aspect of the invention, a method for assigning audio services (32-44) among users in a home entertainment system environment is provided, wherein the environment includes a computing system (102) comprised of a plurality of audio services (32-44) accessible by a plurality of audio sets associated with users of the system.

The present invention generally relates to in a home environment, and more specifically, to a system and method for managing the assignment of multiple services among one or more users in a home entertainment system environment.

Many households have multiple television and devices including TVs, video cassette recorders (VCRs), digital versatile disc (DVD) players, stereos, and the like (“controllable devices”). A major force of innovation since at least the early 1990's has been, at least for a home environment, the convergence of the multiple television and devices around a central e-hub, which is typically a personal computer (for example a Windows Media Center configuration). By co-locating the multiple devices in a home environment, such as a main living room entertainment center, device usage conflicts invariably arise. That is, the remote controllers (“remotes”) for these various controllable devices only work well with the one device or brand of device that they were created to control. However, given the relative close proximity of each device in the home entertainment center, whenever a user attempts to actuate a remote control unit to control an intended service it may inadvertently send a remote command to another unintended service causing the unintended service to change its state of operation (e.g., change television channel or volume setting).

It would be an improvement over the prior art to have a system and method for managing the control of multiple services among one or more users in a home entertainment system environment by exclusively assigning each user's access device to a single service of interest to the user (i.e., a preferred service).

A system and method is provided that addresses the afore-mentioned deficiencies and associated problems that manages the assignment of multiple services among one or more users in a home entertainment system environment by exclusively assigning each user's access device to a single service of interest to the user (i.e., a preferred service).

In one embodiment, each users access device (e.g., “remote control”), is capable of selecting and controlling a single service of interest to a user (i.e., a preferred service) from among a plurality of services available in a home entertainment system environment. Selection of one or more preferred services is facilitated through use of service label identifiers. Subsequent to selecting a preferred service, at least a portion of the user's remote access device is automatically assigned to exclusively control the preferred service.

Advantageously, only the user selected service is controlled by at least a portion of the user's access device thereby obviating unintended control of other non-selected services in close proximity. A further advantage is that multiple users may simultaneously control respective preferred services without concern for control conflicts between the services.

Further provisions are included for allowing users, at any point in time, to switch from a currently selected preferred service to another preferred service by re-assigning the user's access device. Provisions are also included to allow two or more users to simultaneously select the same preferred service from their respective access devices, which may be desirable, for example, in gaming applications.

In one aspect of the invention, a method for assigning audio services among users in a home entertainment system environment including a computing system comprised of a plurality of audio services accessible by a plurality of user's via user worn audio sets comprises: (i) accessing the computing system via a remote access device; (ii) displaying to one of the plurality of users, the plurality of audio services; (iii) selecting, via the remote access device, at least one preferred audio service by one of the users; and (iv) assigning the at least one preferred audio service to an audio set associated with the at least one user responsive to the selection.

Referring now to the drawings in which like reference numbers represent corresponding parts throughout, where:

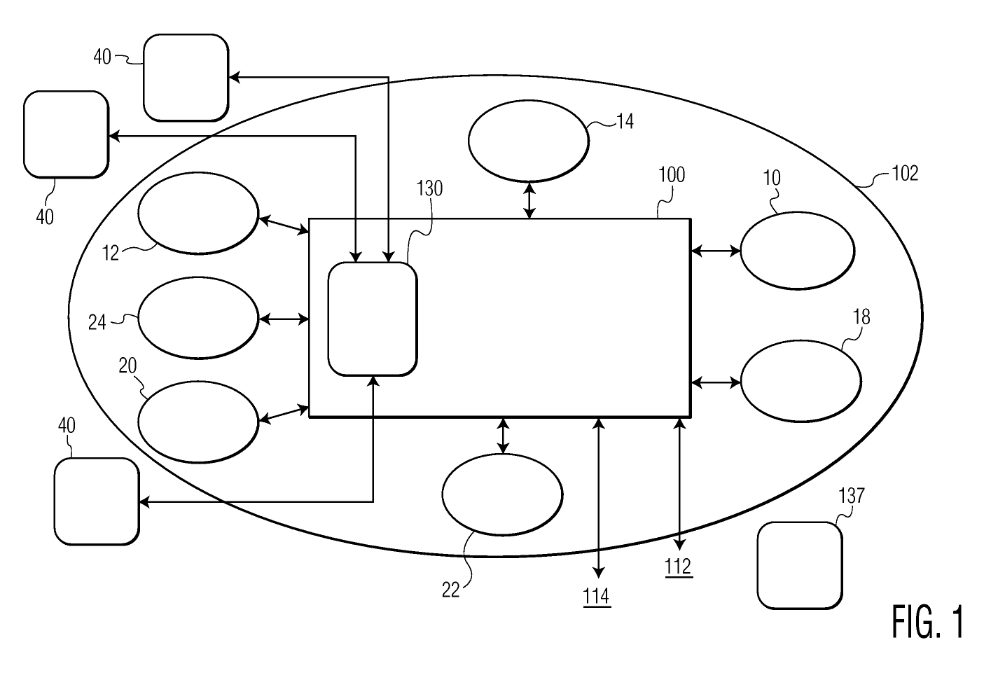

FIG. 1 is an exemplary home system environment (e.g., a living room) in which embodiments of the computer system 102 of the invention may be used;

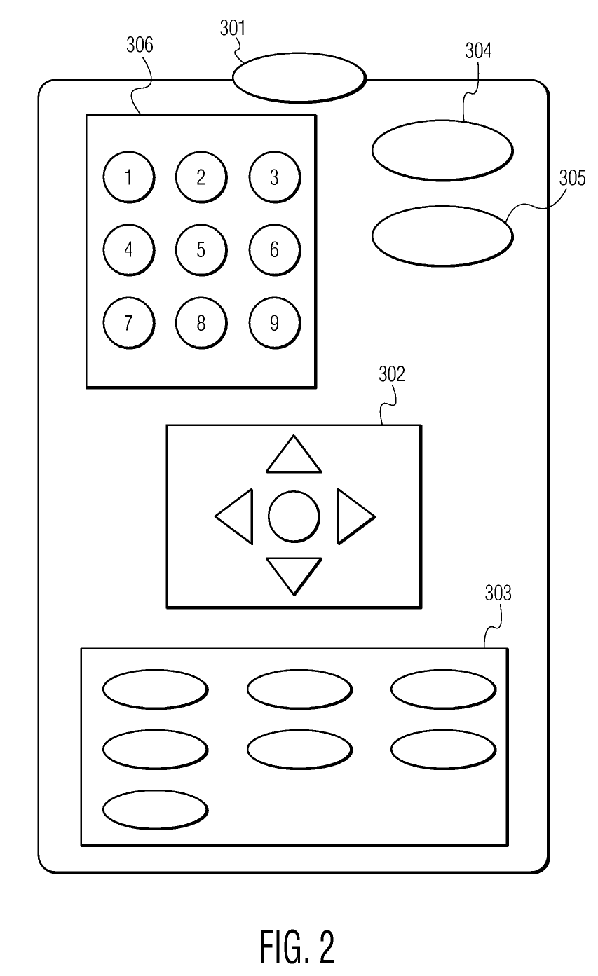

FIG. 2 is an illustration of one embodiment of a remote access device 40;

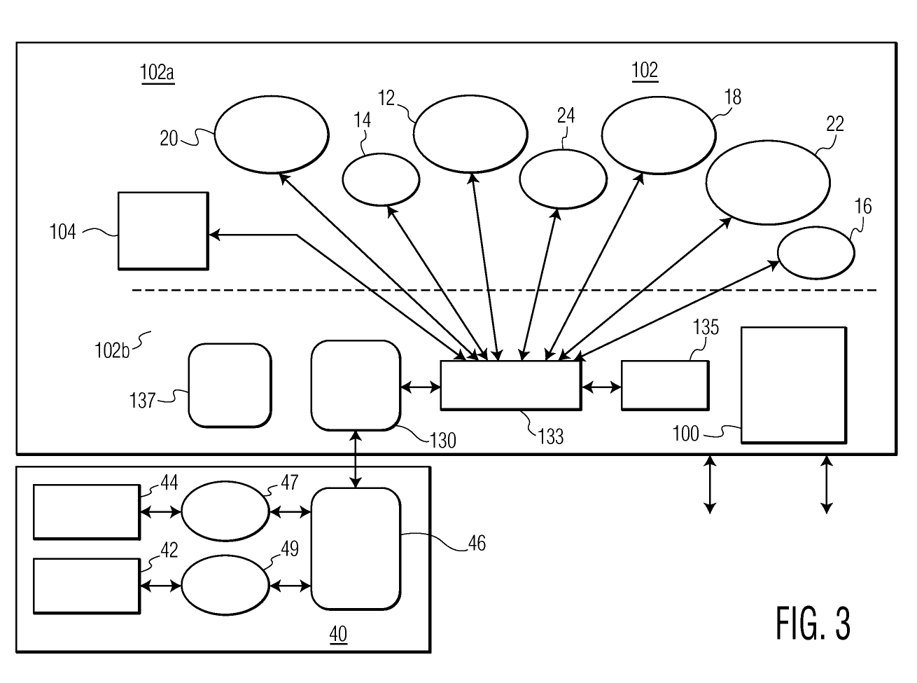

FIG. 3 is a block diagram illustrating the internal configuration of the computing system 102 of FIG. 1 and the remote access device 40 of FIG. 2;

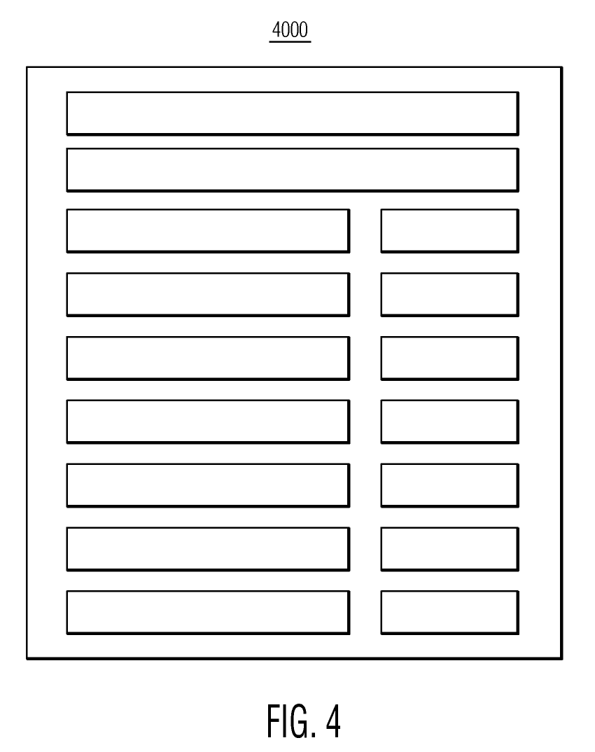

FIG. 4 is an illustration of an exemplary GUI interface 4000 which may be shown to a user in response to the user pressing the “Service management” key 304 from the user's remote access device 40;

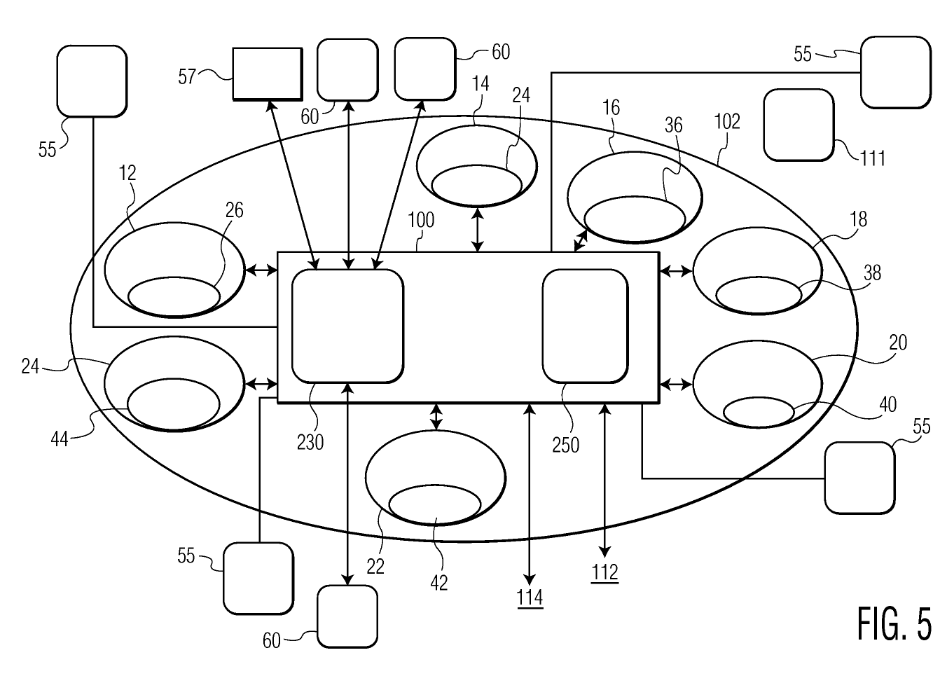

FIG. 5 is a block diagram of a second embodiment of the invention, showing the computer system 102 including a number of audio services 32-44 where each audio service 32-44 is associated with a corresponding service 12-24.

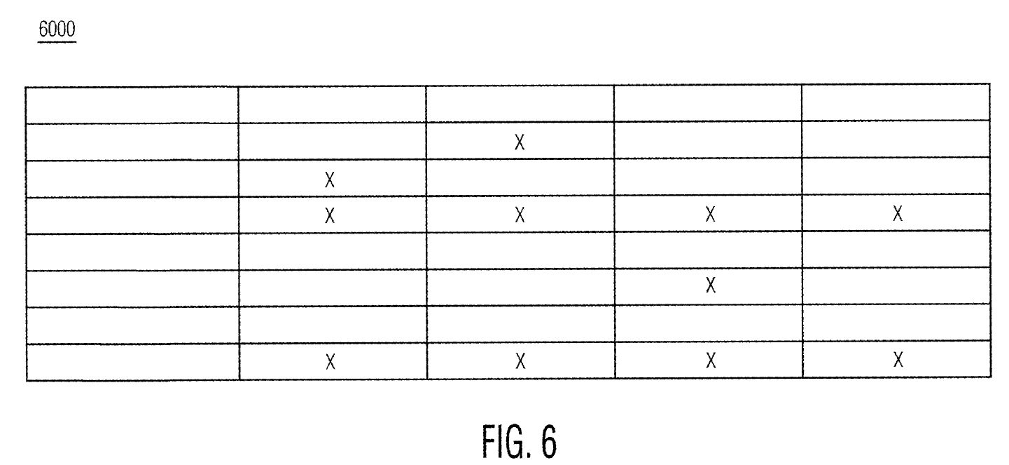

FIG. 6 is an illustration of an exemplary GUI interface 6000 which may be shown to a user in response to the user pressing the “Audio management” key 305 from a remote access device 40; and

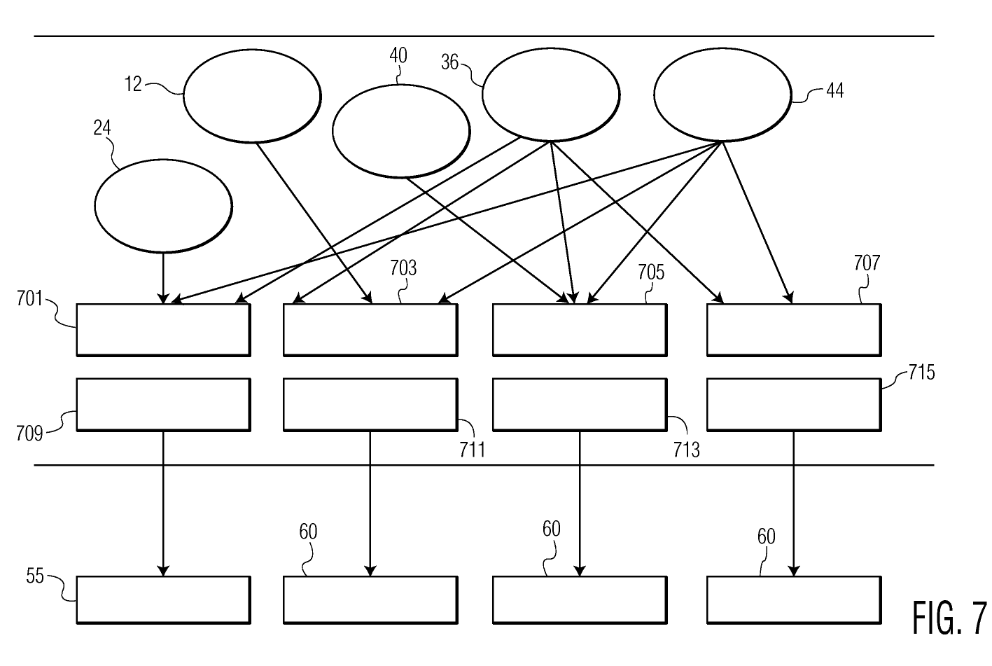

FIG. 7 is a block diagram illustrating a method for combining audio signals for transmission to the audio sets 60 and the loud speaker 55.

While the present invention is described herein with reference to illustrative embodiments for particular applications, it should be understood that the invention is not limited thereto. Those skilled in the relevant art(s) with access to the teachings provided herein will recognize additional modifications, applications, and embodiments within the scope thereof and additional fields in which embodiments of the present invention would be of significant utility.

Reference in the specification to “one embodiment”, “an embodiment” or “another embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

One embodiment of the present invention will be described with reference to the drawings.

Referring to FIG. 1, an exemplary home system environment (e.g., a living room) is shown in which embodiments of the computer system 102 of the invention may be used. The computer system 102 includes a centralized computing device 100, configured as an electronic hub or e-hub to coordinate the lifecycle of the various services 12-24. The users of the computer system 102 of the invention access the various services 12-24 via corresponding remote access devices 40, three of which are shown by way of example. The term “remote access device” generally refers to devices that are dedicated to remotely accessing the computing system 102 such as a remote control device, a wired or wireless keyboard, a PDA, a laptop, and in the future, a wide range of other devices which are not presently known or which are presently known but which are not presently susceptible to reliable two-way remote access. Such devices, now known or later developed, are included within the possible types of base units useful with the present invention.

Access may be via wired or wireless means. In wireless connections, the remote access devices 40 do not physically connect to the computer system 102. For example, the remote access device and the computing device 100 may include a transmitter and receiver for wireless communications therebetween. By way of example, the connection interface may include one or more of the following interfaces: FM, RF, Bluetooth, 802.11, UWB (ultra wide band), IR, magnetic link (induction), WIFI, TCP/IP and/or the like.

In brief, FM (frequency modulation) is a method of impressing data onto an alternating-current (AC) wave by varying the instantaneous frequency of the wave. This scheme can be used with analog or digital data. RF generally refers to alternating current AC having characteristics such that, if the current is input to an antenna, an electromagnetic field is generated suitable for wireless broadcasting and/or communications. The frequencies associated with RF cover a wide range of the electromagnetic radiation spectrum as for example from about 9 kHz to thousands of GHz. Bluetooth generally refers to a computing and telecommunications industry specification that describes how mobile phones, computers and personal digital assistants can easily interconnect with each other using short range wireless connection. 802.11 generally refers to a family of specification for wireless local area networks (WLANs) developed by a working group of the Institute of Electrical and Electronics Engineers (IEEE). UWB refers to a wireless technology for transmitting large amounts of digital data over a wide spectrum of frequency bands with very low power for a short distance. IR generally refers wireless technologies that convey data through infrared radiation.

Further, access to the services by such users may occur on the same or different display monitors (not shown) of the centralized PC 102. For example, in the case of simultaneous usage, one user may be watching TV, while a second user may be reading his or her email with a third user watching a DVD. A single display monitor 137 is shown for ease of explanation.

In the illustrated embodiment of FIG. 1, the exemplary services 12-24 include: a video recorder service 12, a television service 14, an email service 16, a video telephony service 18, an audio system service 20, a DVD player/recorder service 22 and an agenda (calendar) service 24. The centralized computing device 100 and the various services 12-24 collectively comprise a computer system 102.

The computer system 102 of FIG. 1 further includes a home stereo speaker system 55 in the living room that is discussed below with reference to the second embodiment.

The computer system 102 of FIG. 1 is connected to the outside world via a cable TV connection 112 and a broadband Internet connection 114 as shown using wired or wireless technology. These external connections provide access to various servers and other sources for a variety of sources of content which may include, for example, video on demand, IPTV, streaming media, Web content, and the like.

An infrared (IR) remote access device 40, which in the present embodiment constitutes the remote access device 40, is shown in FIG. 2. In FIG. 2, the buttons of the remote access device 40 for realizing the functions essential to the illustrated embodiment are only shown. The buttons required for the actual use of the available services 12-24 are not limited to the illustrated buttons.

In FIG. 2, the infrared (IR) remote access device 40 includes a light transmitter 305 for infrared communication with the infrared receiver 130 of the computing system 102, a conventional numeric keypad 306, cursor keys 302 for moving a selection cursor in the up, down, right and left directions, a “Service management” key 304 dedicated to calling up a GUI interface related to service management functions, and seven color keys; “blue”, “red”, “green”, “yellow”, “orange”, “purple”, and “gray”, collectively labeled 303, for selecting the various services 12-24.

Next, FIG. 3 shows an example of the internal configuration of the computing system 102 and a representative infrared remote access device 40, according to the present illustrated embodiment.

The computing system 102 includes a processor 100 configured to manage the functions of the computer system 102. The processor 100 in one embodiment is a PC, however, other types of processors that are sufficient to carry out the required functionality as well as receive inputs may also be used. Inputs include, without limitation, text, graphics, voice, audio, or video.

In an embodiment, the processor 100 may be a PC executing applications compatible with the Windows™ operating system available from Microsoft Corporation of Redmond, Wash. For example, in at least one embodiment, the PC may execute the Microsoft™ Windows Media Center™ operating system. Other embodiments are possible, including other operating systems and computing platforms. The processor 100 may also be embodied as a notebook, laptop, palmtop, handheld processing device, e-hub consumer device and/or another type of computing device.

The various modules which comprise the computer system 102 utilize some form of control logic. Such control logic is typically implemented using software, the software may be stored in a computer program product and loaded into the computer system 102 using a secondary memory device, a removable storage drive, or a communications interface. The control logic (software), when executed by the computer system 102, causes the computer system 102 to perform the functions of the invention as described in embodiments herein.

The computing system 102 is shown to be generally divided into a “Services” section 102a and a “Middleware/System Software” section 102b. Each of which are described as follows.

The Services section 102a of the computing system 102 includes a services manager module 104 and a number of services 12-24 provided in the living room of the home entertainment system environment.

The service manager module 104 is a continuously running process that manages the lifecycle of the services 12-24 including starting and stopping the services upon user request. The services manager module 104 also provides a graphical user interface (GUI), via display 137, to carry out these and other management functions to be described.

The “Middleware/System Software” section 102b of the computing system 102 includes the display 137, an infrared receiver 130, a key dispatcher 133, a services table 135 and processor 100.

In an embodiment, the remote access device 40 includes a label manager 44 which assigns the color keys 303 to respective ones of the available services. In operation, when a user presses a particular color key, e.g., “green”, the label manager 44 configures the various keys of the remote access device 40 for the service associated with the color green. For example, if the color green is associated with the TV service 14, then upon pressing the green color key on the remote access device 40, the keys of the device 40 are configured to control the various functions of the TV service 14, such as, for example, loudness, brightness, mute, etc.

It should be understood that, at a configuration stage, the various services 12-24 are assigned a unique label identifier, which can be a color, a number or any other indicia for uniquely identifying the respective services 12-24 to users.

In operation, when a user decides to select (or de-select) a service, the user presses the “Service Management” key 304 on the remote access device 40. In response, a GUI interface 4000 is displayed to the user on the display 137 of the computer system 102.

FIG. 4 is an illustration of an exemplary GUI interface 4000 which may be shown to a user in response to the user pressing the “Service management” key 304 from the user's remote access device 40. The GUI interface 4000 is generated by the service manager module 104 of the computer system 102. The GUI interface 4000 includes a table listing of the available services 12-24 of the computer system 102 and a corresponding label identifier which uniquely identifies each service 12-24. For example, referring to the GUI interface 4000 of FIG. 4, the “video recorder” service 12 is uniquely identified with a “red” label identifier. As stated above, the label identifiers may be different in different embodiments. For example, the label designations may be color coded labels, numerically coded labels, icons or any other indicia uniquely identifying each service 12-24. In the present illustrative embodiment, the user accesses a preferred service 12-24 by pressing the corresponding color key 303 on the remote access device 40 associated with the desired service 12-24. For example, if the user is interested in accessing the “video recorder” service 12, the user presses the “red” color key 303 on the remote access device 40. This causes at least a portion of the keys of the remote access device 40 to become dedicated to the operations of the “video recorder” device.

Pressing the red color key 303 is detected by the label manager 44 in the remote access device 40 causing the remote control device 40 to switch to the “red” mode, corresponding to label code 47, which is stored in the infrared transmitter 46.

Thereafter, when the user presses any one of the keys on the remote access device 40 dedicated to the “video recorder” service 12 mode, the key detection module 42 in the remote access device 40 senses and captures the key press and translates the captured key press to an appropriate key code 49 to be forwarded to be the infrared transmitter module 46 for transmission along with the stored label code 47 as a data modulated infrared signal to the infrared receiver 130 of the computing system 102.

Upon receiving the label code 47 and key code 49 at the infrared receiver 130, they are forwarded to the key dispatcher module 133 for processing. For each key code 49 received from the infrared transmitter 130, the key dispatcher 133 dispatches the corresponding key to the appropriate service 12-24 based on the received label code 47. This process is repeated for each key press on the remote access device 40 until such time as the user de-selects the currently selected preferred service.

When the user elects to gain access to another preferred service 12-24, the user presses the “Service management” key 304 again which triggers the display of a GUI interface 4000 once more on the display 137.

In one embodiment, selection of another preferred service automatically causes the previously selected preferred service to be de-assigned. In other words, the previously selected preferred service is no longer assigned to the user's remote access device 40 and control is relinquished.

In one embodiment, selection of an additional preferred service does not automatically result in the presently selected preferred service to become de-assigned. Instead, the user's remote control device 40 is simultaneously assigned to both the additional preferred service and the previously selected preferred service.

FIG. 5 is a block diagram of a second embodiment of the invention, showing the computer system 102. In the second embodiment, there is shown a number of audio services 32-44 where each audio service 32-44 is associated with a corresponding service 12-24. The audio services 32-44 may be accessed independently of, or in addition to, the services 12-24.

Users are provided with audio sets 60 which are assigned a unique frequency (e.g., audio set 1=40 Khz, audio set 2=50 Khz, etc.). The term “audio set” as used herein encompasses any current or futuristic device having a capability for reproducing audio signals, such as, for example, loudspeakers, PDAs, mobile phones.

The assigned frequencies correspond to signal broadcast frequencies for transmitting desired audio information from the computer system 102 to the audio sets/users. In certain embodiments, the audio sets 60 preferably include a microphone configured to facilitate bi-directional audio communication between the audio sets 60 and the audio transmitter/receiver module 230 of the computing system 102.

To access an audio service 32-44, a user presses the “Audio management” key 305 on the access device 57. In response to the key press, the user is shown a GUI display, such as the one illustrated in FIG. 6.

FIG. 6 is an illustration of an exemplary GUI interface 6000 which may be shown to a user in response to the user pressing the “Audio management” key 305 from a access device 57. The GUI interface 6000 is generated by the service manager module 104 of the computer system 102. The GUI interface 6000 allows a user, via access device 57 (or via microphone input), to select one or multiple audio services 6002 for playback on the user's audio set 60 and/or the loud speaker system 55 by marking the appropriate row/column location with an indicator (e.g., “X”). For example, in the GUI interface 6000 of FIG. 6, the user associated with audio set 1 prefers to receive audio input from three sources, namely, the video recorder audio source 22, the email audio source 36 (to possibly notify the user that an email has arrived) and the agenda audio source 44 (to possibly notify the user that there is an imminent appointment). The user, using the access device 57, clicks on the appropriate rows to select the three audio sources as shown.

Each audio service 32-44, selected by the various users, are combined at the computer system 102 into a composite audio signal and modulated at a modulating frequency corresponding to the particular audio set established during configuration.

FIG. 7 is a block diagram illustrating a method for combining audio signals for transmission to the audio sets 60 and the loud speaker 55. The audio combiner module 250 of the computing system 102 is configured to properly combine one or more audio signals sourced from the various audio services, upon user requests. The audio combiner module 250 utilizes input data from the services table 135 that defines the current user audio service access requests, as represented by GUI interface 6000 of FIG. 6. As described above, the user associated with audio set 1 prefers to receive audio input from three sources, namely, the video recorder audio source 22, the email audio source 36 and the agenda audio source 44. For user 1, the three audio sources are combined in the audio signal combiner 703. The combined signal modulates an RF carrier signal that is preset during configuration at a particular RF transmitter frequency (i.e., frequency 1) 711 unique to audio set 1. The RF signal is broadcast to audio set 1. Similar operations are performed for the loud speaker 55 and audio sets 2 and 3.

In one embodiment, the computer system 102 constructs a single digital multiplexed signal derived from the outputs of the four combiner modules 701-707 shown in FIG. 7. In this embodiment, the audio sets include sufficient processing capability to extract only the portion of the multiplexed signal relevant to the particular audio set.

It should be appreciated that other techniques for combining and transmitting the audio information, utilizing principles well known in the art, are within contemplation of the invention.

Although this invention has been described with reference to particular embodiments, it will be appreciated that many variations will be resorted to without departing from the spirit and scope of this invention as set forth in the appended claims. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts is intended to be required unless specifically indicated.

1. A method for assigning services among users in a home entertainment system environment, wherein said environment includes a computing system (102) comprised of a plurality of services (12-24), the method comprising the acts of:
(i) accessing said computing system (102) via said user's remote access device (40);
(ii) associating said plurality of services (12-24) with corresponding service label identifiers;
(iii) selecting, via said user's remote access device (40), a preferred service from among said plurality of services (12-24) using said preferred service's corresponding label identifier; and
(iv) assigning said preferred service (12-24) to said user's remote access device (40) in response to said selection, where upon said assignment configures said user's remote access device (40) to control the functions of said preferred service.

2. The method of claim 1, wherein said assignment configuring said user's remote access device (40) to control the functions of said preferred service further comprises dedicating at least a subset of the keys of said remote control device to exclusively controlling the functions of said preferred service.

3. The method of claim 2, wherein said label identifier is one of a color label identifier, a numeric label identifier and an iconic label identifier.

4. The method of claim 1, wherein said act of selecting further comprises the acts of:
displaying to said user, said plurality of services (12-24) and their corresponding service label identifiers;
identifying said preferred service and said corresponding service label identifier;
using said remote access device (40) to select said service label identifier corresponding to said preferred service.

5. The method of claim 1, further comprising the acts of:
selecting, via said user's remote access device (40), an additional preferred service from among said plurality of services (12-24) using said additional preferred service's corresponding label identifier; and
assigning said additional preferred service to said user's remote access device (40) in response to said selection, where upon said assignment configures said user's remote access device (40) to control the functions of said additional preferred service.

6. The method of claim 5, wherein said user's remote control device (40) maintains said previously assigned preferred service.

7. The method of claim 5, wherein said user's remote control device (40) does not maintain said previously assigned preferred service.

8. The method of claim 1, wherein said act of accessing said computing system (102) via a user's remote access device (40) is communicatively coupled using one of a wired and wireless link.

9. The method of claim 8, wherein said wireless link is compatible with at least one of an IEEE 802.11b or related wireless network standard, a Bluetooth-based wireless network protocol and an infrared communication protocol.

10. A method for assigning audio services (32-44) among users in a home entertainment system environment, wherein said environment includes a computing system (102) comprised of a plurality of audio services (32-44) accessible by a plurality of user's associated audio sets, the method comprising the acts of:
accessing said computing system (102);
displaying to a user, said plurality of audio services (32-44);
selecting by said user, at least one preferred audio service; and
assigning said at least one preferred audio service to an audio set associated with said user responsive to said selection.

11. The method of claim 10, further comprising de-selecting the plurality of audio services (32-44).

12. The method of claim 10, wherein said audio set is a microphone headset.

13. The method of claim 10, wherein said act of assigning said at least one preferred audio service to an audio set associated with said at least one user in response to said at least one user selection, further comprises the acts of:
combining audio signals corresponding to said at least one preferred audio service into a single combined audio signal; and
transmitting said combined audio signal to said at least one user.

14. The method of claim 13, further comprises dedicating a unique transmission channel to each of said audio sets.

15. The method of claim 13, wherein said act of transmitting said combined audio signal to said at least one user, further comprises transmitting said combined audio signal over one of said unique dedicated channels corresponding to said audio set associated with said at least one user.

16. A system supporting the assignment of services among users in a home entertainment system environment, wherein said environment includes a computing system (102) comprised of a plurality of services (12-24), the system comprising:
means for accessing said computing system (102) via said user's remote access device (40);
means for associating said plurality of services (12-24) with corresponding service label identifiers;
means for selecting, via said user's remote access device (40), a preferred service from among said plurality of services (12-24) using said preferred service's corresponding label identifier; and
means for assigning said preferred service (12-24) to said user's remote access device (40) in response to said selection, where upon said assignment configures said user's remote access device (40) to control the functions of said preferred service.

17. The system of claim 16, wherein said means for assigning further comprises means for dedicating at least a subset of the keys of said remote control device to exclusively controlling the functions of said preferred service.

18. The system of claim 16, wherein said means for selecting further comprises:
means for displaying to said user, said plurality of services (12-24) and their corresponding service label identifiers;
means for identifying said preferred service and said corresponding service label identifier;
means for using said remote access device (40) to select said service label identifier corresponding to said preferred service.

19. The system of claim 16, further comprising:
means for selecting an additional preferred service from among said plurality of services (12-24) using said additional preferred service's corresponding label identifier; and
means for assigning said additional preferred service to said user's remote access device (40) in response to said selection, where upon said assignment configures said user's remote access device (40) to control the functions of said additional preferred service.

20. A system for assigning audio services (32-44) among users in a home entertainment system environment, wherein said environment includes a computing system (102) comprised of a plurality of audio services (32-44) accessible by a plurality of user's associated audio sets, the system comprising:
means for accessing said computing system (102);
means for displaying to a user, said plurality of audio services (32-44);
means for selecting, at least one preferred audio service by said user; and
means for assigning said at least one preferred audio service to an audio set associated with said user responsive to said selection.

21. The system of claim 20, further comprising means for de-selecting the plurality of audio services (32-44).

22. The system of claim 20, wherein said means for assigning further comprises:
means for combining audio signals corresponding to said at least one preferred audio service into a single combined audio signal; and
means for transmitting said combined audio signal to said user.

23. The system of claim 22, wherein said means for transmitting further comprises means for transmitting said combined audio signal over one of said unique dedicated channels corresponding to said audio set associated with said user.
